(19) United States
(12) Patent Application Publication
(10) Pub. No.: US 2009/0097593 A1
(43) Pub. Date: Apr. 16, 2009

(54) BROADCAST DEMODULATION DEVICE

(75) Inventors: Makoto HAMAMINATO, Kawasaki (JP); Naoto Adachi, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki-shi (JP)

(21) Appl. No.: 12/180,867

(22) Filed: Jul. 28, 2008

(30) Foreign Application Priority Data
Oct. 12, 2007 (JP) 2007-267225

(51) Int. Cl. H04L 27/06

(52) U.S. Cl. 375/340

(57) ABSTRACT

In a demodulation device with a plurality of branches, the receiving quality of each branch and signal quality after composing signals from the plurality of branches is inspected. If the signal quality is good, the operation of a branch whose receiving quality of each branch is the worst is stopped. When activating a stopped branch, the synchronous detection information of an already operated branch is applied to a branch to be newly activated and time needed for a newly activated branch to become synchronous is reduced.

### BACKGROUND OF THE INVENTION

1. Field of the Invention

The present invention relates to a broadcast demodulation device for receiving digital broadcast.

2. Description of the Related Art

In portable and vehicle-mounted terminals for receiving digital broadcast, there is a method for preparing a plurality of demodulation units aiming at mobile reception to improve receiving performance by diversity reception. Specifically, by receiving signals of the same channel by two or more antennas and applying a maximum ratio combining process to signals received by these antennas, high-quality signals are demodulated.

When applying diversity reception, receiving performance can be improved. However, since there is a plurality of demodulation units, power consumption increases.

In the demodulation process unit corresponding to diversity reception when only a part of branches is re-synchronized and single reception is switched to diversity reception, the same synchronization process as when starting reception is always applied to each of branches not synchronized yet even if there is a synchronized branch.

Therefore, when single reception is switched to diversity reception, it takes time to output normal demodulation data to the output device of a terminal.

A receiving apparatus is known which is provided with a plurality of independently controllable branches which can also operate as a diversity receiving apparatus and a plural-channel simultaneous receiving apparatus.

### SUMMARY OF THE INVENTION

A demodulation circuit according to one aspect of the present invention comprises a first demodulation circuit for receiving a signal and generating a first demodulation signal, a second demodulation circuit for receiving the signal and generating a second demodulation signal, a combiner unit for generating a combined demodulation signal by composing the first and second demodulation signals, a first detection unit for detecting a receiving condition on the base of the combined demodulation signal and outputting a detection signal and a control unit for stopping the combiner of either of the first or second demodulation circuit on the base of the combined demodulation signal and controlling the stoppage of either of the first or second demodulation circuit.

A demodulation device according to one aspect of the present invention comprises a first synchronous unit for extracting a first clock from a carrier signal, a second synchronous unit for extracting a second clock from the carrier signal, a first detection circuit for outputting a first detection signal indicating the out-of-synchronization state of the first synchronous unit, a selection circuit for inputting the first synchronous information of the first synchronous unit and the second synchronous information of the second synchronous unit and transmitting the second synchronous information to the first synchronous unit on the basis of the first detection signal, a first demodulation circuit for demodulating the output of the first synchronous unit, a second demodulation circuit for demodulating the output of the second synchronous unit and a combiner unit for composing the first demodulation signal of the first demodulation circuit and the second demodulation signal of the second demodulation circuit.

### BRIEF DESCRIPTION OF THE DRAWINGS

FIG. 1 shows the configuration of a popular digital broadcast demodulation device.

FIG. 2 shows the configuration of a digital broadcast demodulation device according to the first preferred embodiment of the present invention.

FIG. 3 is a flowchart showing the operation of the digital broadcast demodulation device according to the first preferred embodiment of the present invention.

FIG. 4 explains a modulation error rate (MER).

FIG. 5 is a flowchart showing the determination method of a receiving condition.

FIG. 6 is a flowchart showing the flow of a process of obtaining the information of another channel in the background using a stopped branch.

FIG. 7 is the entire block diagram of a demodulation device showing the second preferred embodiment of the present invention.

FIG. 8 typically shows a process from the reception start of a signal until the establishment of synchronization.

FIG. 9 shows the configuration of the digital broadcast demodulation device according to the second preferred embodiment of the present invention (No. 1).

FIGS. 10A and 10B show the configuration of the digital broadcast demodulation device according to the second preferred embodiment of the present invention (No. 2).

FIG. 11 explains the effect of the second preferred embodiment.

FIG. 12 is the block configuration diagram of a digital broadcast demodulation device according to the third preferred embodiment combining both first and second preferred embodiments.

FIG. 13 is the block configuration diagram of a digital broadcast demodulation device according to the third preferred embodiment combining both first and second preferred embodiments.

FIGS. 14A and 14B are the block configuration diagram of a digital broadcast demodulation device according to the third preferred embodiment combining both first and second preferred embodiments.

FIG. 15 is a flowchart showing the operation in the case where two branches are used in the third preferred embodiment.

FIG. 16 is a flowchart showing the operation in the case where three or more branches are used in the third preferred embodiment.

FIG. 17 is the block configuration diagram of a digital broadcast receiving apparatus provided with a digital broadcast demodulation device to which the preferred embodiment of the present invention is applied.

### DESCRIPTION OF THE PREFERRED EMBODIMENTS

According to one preferred embodiment of the present invention, a diversity demodulation device provided with a plurality of demodulation processing units (hereinafter one demodulation device is called one branch) comprises a unit for detecting the modulation error rate (hereinafter abbreviated as MER) of each branch, a unit for detecting the MER after diversity combiner, a unit for controlling the on/off of the diversity combiner and a unit controlling the on/off of the operational clock of each branch. It further comprises a unit for stopping the combiner process of branches in worse order of the receiving condition in descending order of MER when determining that a receiving condition is good on the basis of the MER after diversity combiner and a unit for stopping the clock of a branch whose combiner process is stopped.

It further comprises a unit for sequentially starting the operation of the clocks of stopped branches one by one when determining that a receiving condition is bad on the basis of the MER of a single reception branch and a unit for starting the combiner process of branches.

It further comprises a unit for storing the stopped state of the clock of each branch and the combiner state of each branch, which can be read from an external control circuit. In single reception, it receives another channel using a branch whose clock is stopped and obtains modulation information and the like.

By adopting the above-described configurations and switching the on/off of a branch according to a receiving condition, the power consumption of the demodulation device can be reduced.

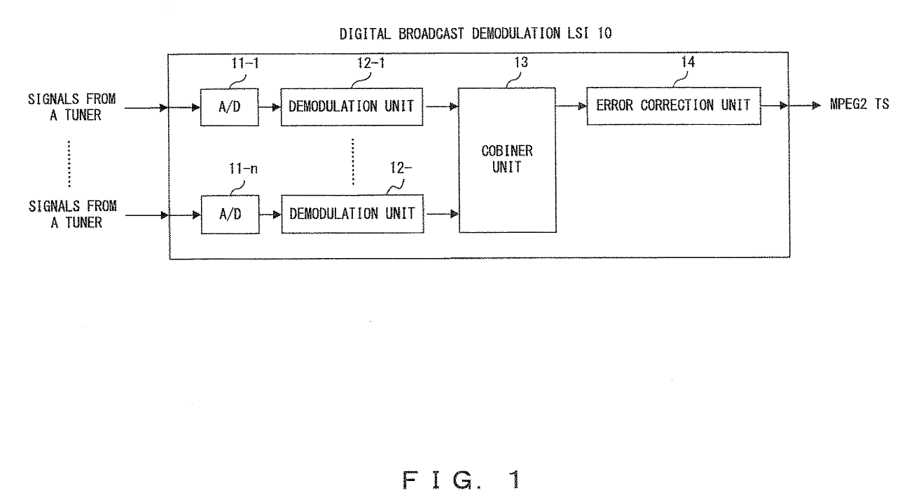

FIG. 1 shows the configuration of a popular digital broadcast demodulation device.

In FIG. 1, signals from each tuner are inputted to a digital broadcast demodulation device 10. In this example, n tuners, which is not shown in FIG. 1, one of which is connected to each of n antennas, are used. In FIG. 1, n is an integer of 2 or more. Each tuner signal is inputted to each of A/D converters 11-1˜11-n and is converted to a digital signal. Then, the digitized signal is inputted to modulation units 12-1˜12-n and is demodulated. Each demodulated signal is combined in a combiner unit 13. For this combiner, for example, a maximum ratio combining method is used. The output of the combiner unit 13 is inputted to an error correction unit 14 and after the error correction, is transmitted to a signal processing unit, which is not shown in FIG. 1, as image data, such as an MPEG 2 signal or the like.

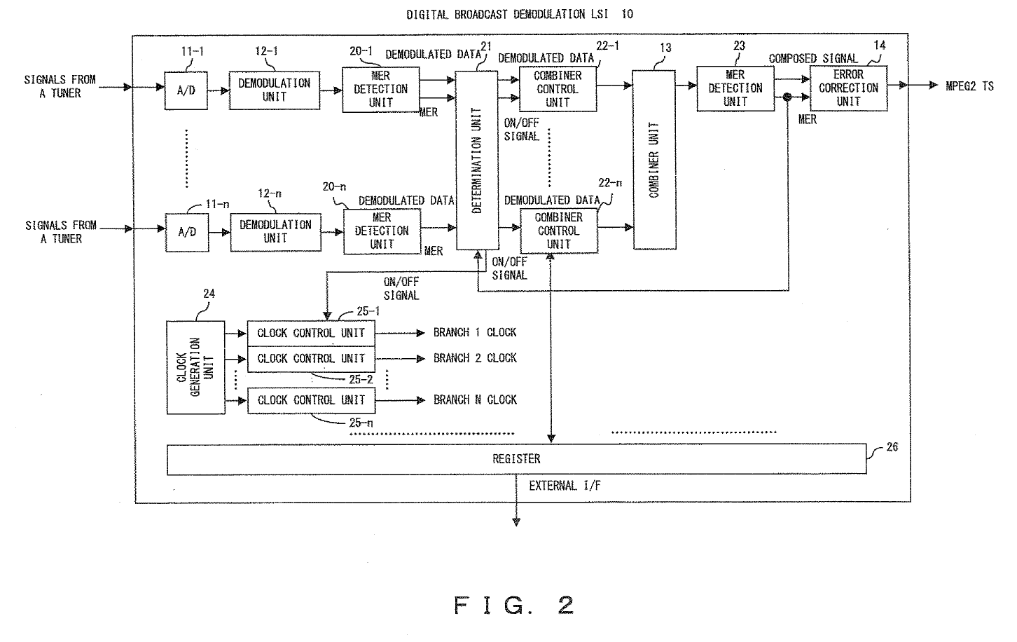

FIG. 2 shows the configuration of a digital broadcast demodulation device according to the first preferred embodiment of the present invention.

In FIG. 2, the same reference numerals are attached to the same components as in FIG. 1 and their descriptions are omitted.

The signal of each branch demodulated in the demodulation units 12-1˜12-n is inputted to MER detection units 20-1˜12-n provided for each branch. In the MER detection units 20-1˜12-n, MER is calculated for each piece of received demodulation data of each branch and is inputted to a determination unit 21 together with the demodulation data. The determination unit 21 inputs the on/off signal of each branch to combiner control units 22-1˜22-n provided in correspondence to each branch, on the basis of the MER value of each branch and the MER of a signal after combiner obtained in an MER detection unit 23. At this moment, the demodulation data is also inputted to each of the combiner control units 22-1˜22-n from the determination unit 21. In each of the combiner control units 22-1˜22-n, it is calculated how the demodulation signal from each branch is weighted and combined, the demodulation date is multiplied by weight and each piece of weighted demodulation data is inputted to the combiner unit 13. In the combiner unit 13, the weighted demodulation data is added and the added result is inputted to the MER detection unit 23. The MER detection unit 23 outputs the MER of the demodulation data after combiner and the demodulation data after combiner. The demodulation data from the MER detection unit 23 is inputted to an error correction unit 14 and after the error correction is outputted as user data, such as image data or the like. However, the MER from the MER detection unit 23 is fed back to the determination unit 21. The determination unit 21 determines which branch should be switched on and which branch should be switched off, on the basis of the MER value from the MER detection units 20-1˜20-n and the MER value of the MER detection unit 23. When it is determined which branch should be switched off, the determination unit 21 inputs an instruction to set a weight used for combiner to “0” to the combiner control units 22-1˜22-n of a branch to be switched off as an on/off signal. The determination unit 21 stops the supply of the operational clock of devices from the A/D converters 11-1˜11-n until the MER detection units 20-1˜20-n of a branch to be switched off. For the operational clock, a clock signal from a clock generation unit 24 built in the digital broadcast demodulation device 10 is used. However, the generated clock signal is supplied to each branch via clock control units 25-1˜25-n provided for each branch. Therefore, a corresponding one of the clock control units 25-1˜25-n stops the transmission of a clock to a branch to be switched off.

The on/off information of a branch which is set in the combiner control units 22-1˜22-n and the clock control units 25-1˜25-n is written into a register 26 and can be read from outside.

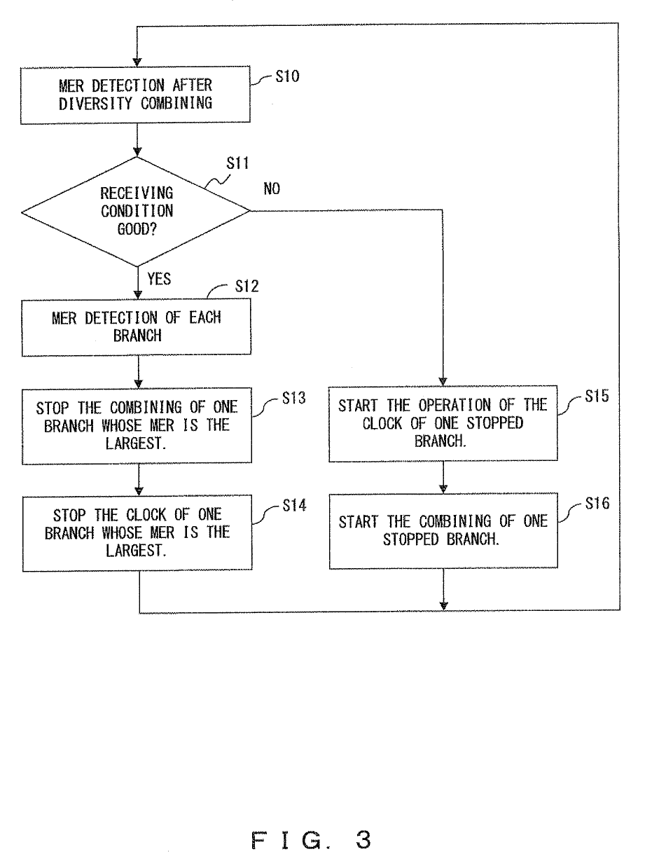

FIG. 3 is a flowchart showing the operation of a digital broadcast demodulation device according to the first preferred embodiment of the present invention.

The flow shown in FIG. 3 shows the process of the determination unit 21 shown in FIG. 2.

After synchronization, the demodulation device detects the MER of the demodulation signal of each branch and the MER of diversity combiner signal. When starting reception, the demodulation device operates in a diversity reception mode. If it is determined that a receiving condition is good, the combiner of one branch is stopped to stop the clock of the branch. In the stoppage of the combiner and clock, one whose MER is the largest, of the branches is selected. Therefore, even if the number of diversity combiner branches decreases, after diversity combiner, a received signal can be suppressed from deteriorating.

If it is determined that a receiving condition is bad and there are branches whose clocks are stopped, the supply of the clock of one of the stopped branches is started and after synchronization diversity combiner is started.

All the above-described operations are independently performed by the digital broadcast demodulation device. The stopped state of the MER, combiner and clock of each branch can be read from outside the demodulation device and the on/off of the combiner and clock of each branch can be also controlled from outside.

If described along FIG. 3, in step S10 MER after diversity combiner is detected and in step S11 it is determined whether a receiving condition is good. MER detected by the MER detection unit 23 shown in FIG. 2. If the determination in step S11 is yes, the MER of each branch ( ) is detected and the combiner of a branch whose MER is the largest is stopped. MER detected by the MER detection units 20-1˜20-n shown in FIG. 2. Specifically, the weight of the signal of a branch whose MER is the worst is set to “0”. Then, in step S14 the clock of a branch whose MER is the largest is stopped and the flow returns to step S10. If the determination in step S11 is no, in step S15 the clock operation of one of the stopped branches is started. Then, in step S16, the weight of the signal from the stopped branch is set to other than “0” and the signal is combined together with a signal from another branch. Then, the flow returns to step S10.

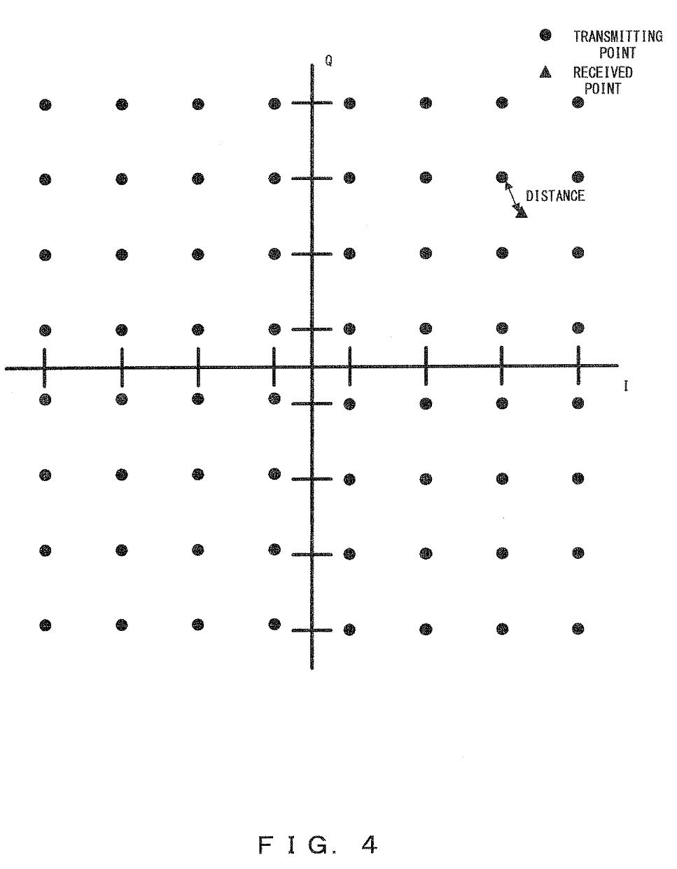

FIG. 4 explains an MER.

An MER is one quality evaluation index of a modulation signal. As shown in FIG. 4, for example, if a modulation method is 64QAM and there is no disturbance in transmission and reception, a received signal coincides with one of transmitting points. If disturbance is added in a transmission path, it never coincides with any transmitting point. In this case, a distance between a received point and a transmitting point closest to the received point or the square of the distance is calculated and their average is used as an MER.

Information for determining a receiving condition is not limited to MER. For example, instead of MER detection performed by the MER detection units 20-1˜20-n of each branch, a received C/N or an AGC feedback value can be also used and instead of MER detection performed by the MER detection unit 23 after combiner, a bit error rate (BER) can be also detected.

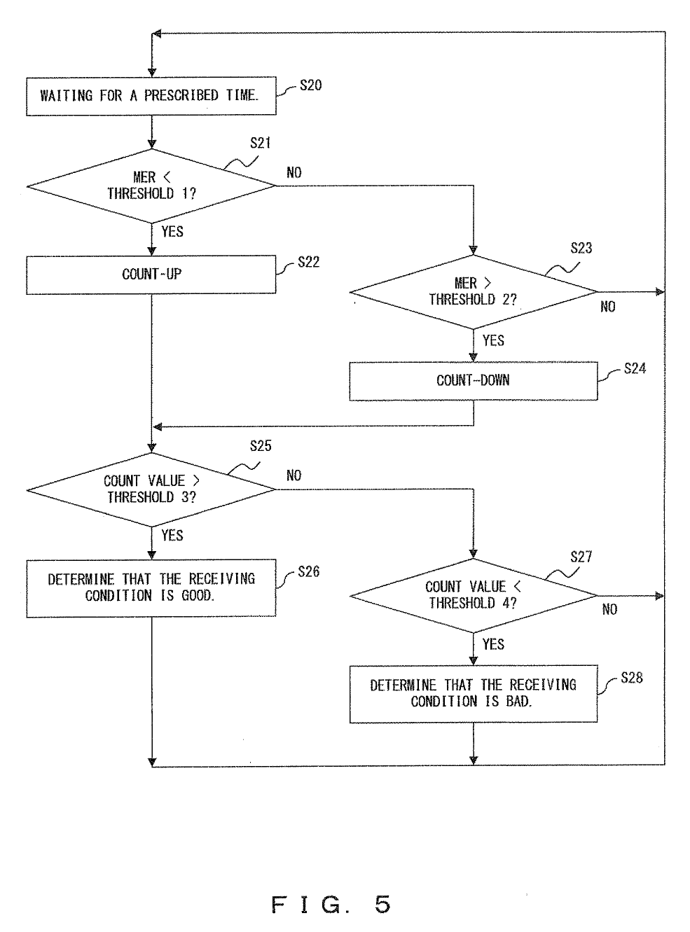

FIG. 5 is a flowchart showing the determination method of a receiving condition.

The flowchart shown in FIG. 5 shows the determination part of step S11 shown in FIG. 3 in details.

An MER and a threshold are compared in prescribed intervals of a period and a counter, which is not shown in FIG. 2 is counted up and down. Two thresholds are prepared for count-up and count-down. Separately, the counter value and the thresholds are compared and a receiving condition is determined. As for this, two thresholds are prepared for good receiving condition determination and bad receiving condition determination.

If described along FIG. 5, in step S20 the device enters a waiting state for a prescribed time. After the prescribed time, in step S21, it is determined whether MER<threshold 1, threshold for count-up. If the determination in step S21 is yes, in step S22, the counter, which is not shown in FIG. 2, is counted up and the flow advances to step S25. If the determination in step S21 is no, in step S27, it is determined whether the count value<threshold 4. If the determination in step S27 is no, the flow returns to step S20. If the determination in step S27 is yes, it is determined that a receiving condition is bad and the flow returns to step S20.

In this case, threshold 1<threshold 2 and threshold 4<threshold 3.

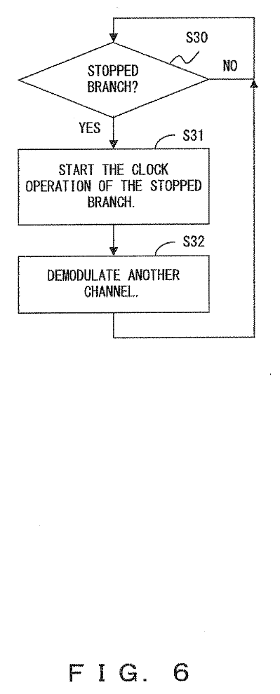

FIG. 6 is a flowchart showing the operation of the first preferred embodiment using this stopped branch for another purpose when there is a stopped branch.

If a receiving condition is good, there is a strong possibility that there may be a stooped branch. If it is determined that there is a stopped branch when the stopped state of each branch is regularly read from outside the digital broadcast demodulation device or the demodulation device issues an offering signal when stopping a branch, as shown in FIG. 6, a control device outside the digital broadcast demodulation device starts the clock supply of the stopped branch, receives another channel different from the view channel and obtains program information.

By the above-described operation, a plurality of channels of demodulation information can be obtained without disturbing viewing.

The operation is described below along FIG. 6. Firstly, in step S30, it is determined whether there is a stopped branch. If the determination in step S30 is no, step S30 is repeated. If the determination in step S30 is yes, in step S31, a clock is supplied to the stopped branch to start the operation of the stopped branch. Then, in step S32, another channel is demodulated using the branch whose operation is started and the flow returns to step S30.

As described above, according to the first preferred embodiment, by switching on/off a branch according to a receiving condition, the power consumption of the digital broadcast demodulation device can be reduced without the deterioration of diversity reception performance.

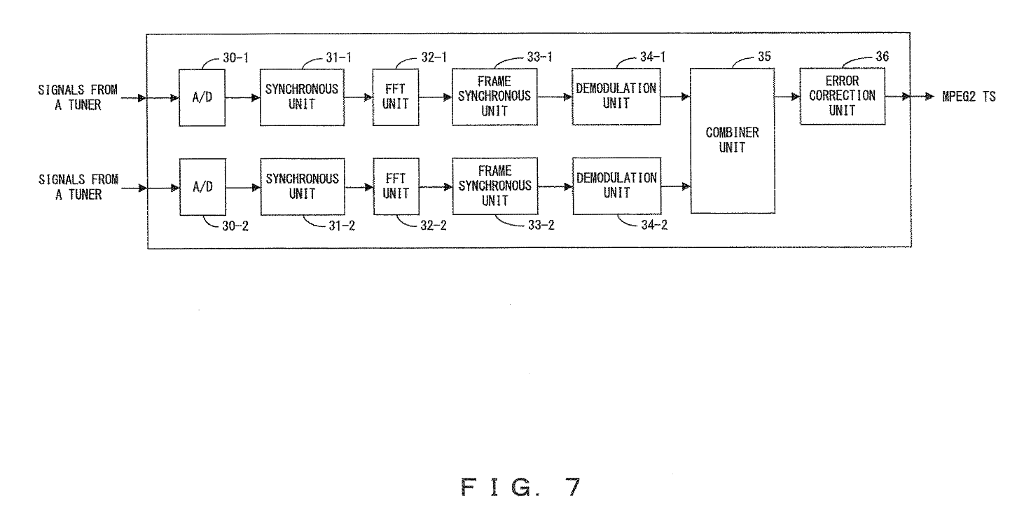

FIG. 7 is the entire block diagram of a demodulation device showing the second preferred embodiment of the present invention.

Although two branches are used in FIG. 7, three or more branches can be also used.

A signal from a tuner is converted into a digital signal by the A/D converters 30-1 and 30-2 and the received signals and the operational clock of the demodulation device are synchronized by the synchronous units 31-1 and 31-2. The signals from the synchronous units 31-1 and 31-2 are fast-Fourier-transformed by the FET units 32-1 and 32-2, respectively. The transformed signals are frame-synchronized by the frame synchronous units 33-1 and 33-2. The frame-synchronous signals are demodulated by the demodulation units 34-1 and 34-2. For example, a maximum ratio combining process is applied to the signals from the two branches by a combiner unit 35. Error correction is applied to the signal after combiner by the error correction unit 36 and is outputted as user data, such as MPEG data or the like.

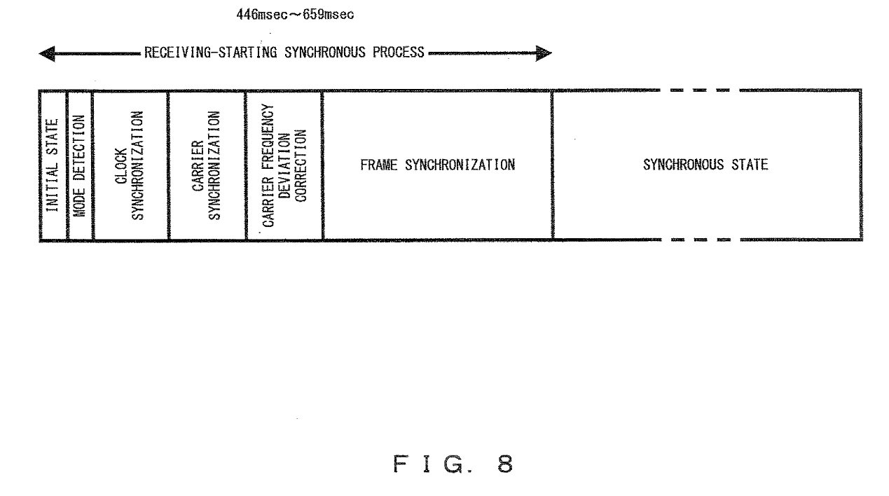

FIG. 8 typically shows a process from the reception start of a signal until the establishment of synchronization.

When a stopped branch starts operation, a mode is detected after an initial state. A mode is detected by detecting the length per symbol of a received signal. Then, a clock is synchronized. In this case, the operational clock of the demodulation device is matched with the timing of the received signal. Then, a carrier is synchronized. In the case of multi-carrier method communications, the frequency of the carrier of the received signal is shifted to a should-be value (on a frequency grid). Then, carrier deviation is corrected. In this case, it is determined whether the position of the carrier frequency of a signal whose carrier is synchronous deviates as wrongly hooked buttons. If it deviates, the carrier frequency is slid in units of carrier frequency intervals. Specifically, it is assumed that four carriers are transmitted on the transmitting side and first, second, third and fourth carriers are located in positions 1, 2, 3 and 4, respectively, and that the carrier positions after carrier synchronization of the first, second, third and fourth carriers become positions 2, 3, 4 and 1, respectively. In this case, each carrier is located in a frequency position which coincides with its should-be frequency grid (carrier is synchronized). When compared with the signals transmitted by the transmitting side, the frequency position of each carrier deviates by one carrier frequency interval. This deviation of one carrier frequency interval is corrected in this carrier deviation correction. Although, in this example, it is assumed that there is deviation of one carrier frequency interval, there can be any number of carrier frequency intervals. The deviation can be also opposite. Specifically, the carrier positions after carrier synchronization of the first, second, third and fourth carriers become positions 0, 1, 2 and 3, respectively. In frame synchronization, the identification number of a received frame is matched with the identification number of a transmitted frame.

As clearly shown in FIG. 8, the mode detection, clock synchronization, carrier synchronization, carrier deviation correction and frame synchronization must be performed until it is fully synchronized after a branch activates. However, if all these synchronizations and the like are performed, it takes about 446 msec˜659 msec to synchronize a branch after activating it, which means too a slow operation.

Therefore, in the second preferred embodiment, a diversity demodulation device with a plurality of demodulation processing units (hereinafter one demodulation processing unit is called one branch) comprises a unit for storing the detected values of carrier synchronization, clock synchronization and carrier frequency deviation in the synchronous process and a unit for applying the stored values of a synchronous branch when re-synchronizing only one branch or when single reception is switched to diversity reception by the control of an external control device to omit the carrier synchronization, clock synchronization, carrier frequency deviation detection and transmission and multiplexing configuration control (TMCC) error correction, of a branch to be re-synchronized.

Thus, when re-synchronizing only one branch or when single reception is switched to diversity reception by the control of an external control device in the diversity reception digital broadcast demodulation device, carrier synchronization, clock synchronization, carrier frequency deviation detection and TMCC error correction in the synchronous process can be omitted.

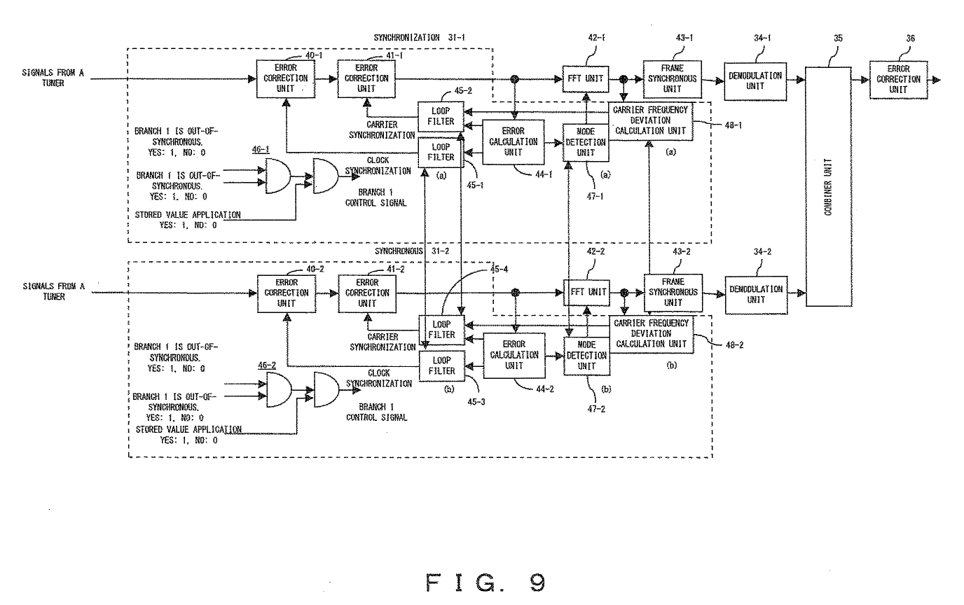

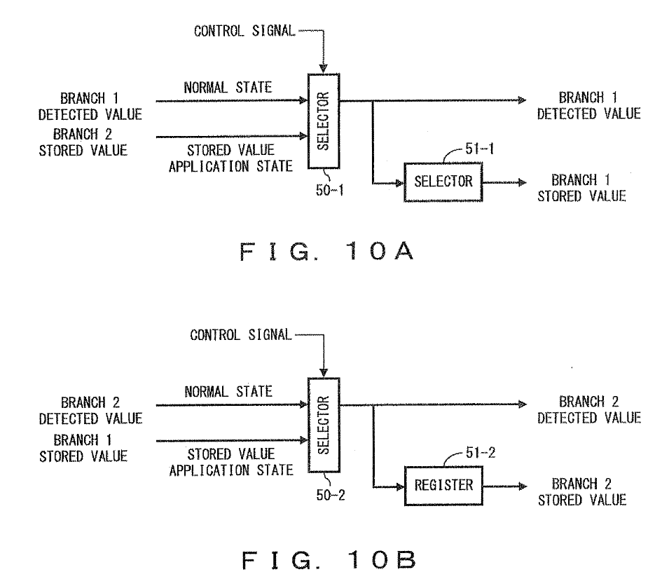

FIGS. 9, 10A and 10B show the configurations of the digital broadcast demodulation device according to the second preferred embodiment of the present invention.

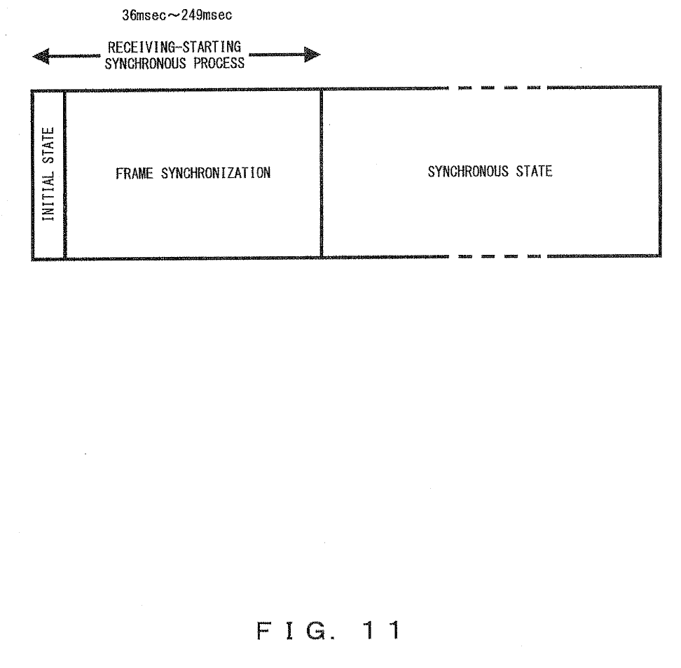

FIG. 11 explains the effect of the second preferred embodiment.

FIG. 9 shows the details around the synchronous units 31-1 and 31-2, the FFT units 32-1 and 32-2 and the frame synchronous units 33-1 and 33-2 shown in FIG. 7. Error correction for clock synchronization and carrier synchronization is applied to a signal from a tuner by the error correction units 40-1, 40-2, 41-1 and 41-2. The output of the error correction units 41-1 and 41-2 is inputted to the error calculation units 44-1 and 44-2, respectively, and also to the FFT units 42-1 and 42-2, respectively. The output of the FFT units 42-1 and 42-2 is inputted to the frame synchronous units 43-1 and 43-2, respectively, and is frame-synchronized. Then, the output is demodulated by the demodulation units 34-1 and 34-2, respectively, and is combined by the combiner unit 35. After the combiner, error correction is applied to the outputs by the error correction unit 36, which are outputted as user data.

The error calculation units 44-1 and 44-2 obtain the output of the error correction units 41-1 and 41-2 and calculates the synchronous deviation of a clock and the synchronous deviation of a carrier. Then, the error calculation result is inputted to the loop filters 45-1˜45-4 and also to the mode detection units 47-1 and 47-2. The output of the mode detection units 47-1 and 47-2 is inputted to the FFT units 42-1 and 42-2 and is used as a control signal for performing FFT with correct symbol length. The carrier frequency deviation calculation units 48-1 and 48-2 obtain the output of the FFT units 42-1 and 42-2 and calculate their carrier frequency deviation. The calculation results are inputted to the loop filters 45-2 and 45-4. The output of the loop filters 45-1˜45-4 is inputted to the error correction units 40-1, 40-2, 40-1 and 40-2, respectively, and is used to perform clock synchronization and carrier synchronization.

The loop filters 45-1 and 45-3 and the loop filters 45-2 and 45-4 are connected each other, the mode detection units 47-1 and 47-2 are connected each other and the carrier frequency deviation calculation units 48-1 and 48-2 are connected each other. Thus, data stored in one register is transmitted to the other. Specifically, the circuit shown in FIG. 10 is provided between these circuits. The branch shown on the upper section in FIG. 9 is branch 1 and the circuit shown in FIG. 10A is provided for the loop filters 45-1 and 45-2, the mode detection unit 47-1 and the carrier frequency deviation calculation unit 48-1. The branch shown on the lower section in FIG. 9 is branch 2 and the circuit shown in FIG. 10B is provided for the loop filters 45-3 and 45-4, the mode detection unit 47-2 and the carrier frequency deviation calculation unit 48-2.

In the circuit shown in FIG. 10A, the detected values of the loop filters 45-1 and 45-2, mode detection unit 47-1 and carrier frequency deviation calculation unit 48-1 of the branch 1 and the stored values of the corresponding circuits of the branch 2 are inputted to the selector 50-1 and either of them is outputted by the control signal of the branch 1. The output of the selector 50-1 is outputted as the detected values of the branch 1 as it is. Simultaneously, the output is stored in the register 51-1 and is inputted to the selector 50-2 of the circuit shown in FIG. 10B of the branch 2 as the stored values of the branch 1. In the circuit shown in FIG. 10B, the detected values of the loop filters 45-3 and 45-4, mode detection unit 47-2 and carrier frequency deviation calculation unit 48-2 of the branch 2 and the stored values of the branch 1 are inputted to the selector 50-2 and either of them is selectively outputted by the control signal of the branch 2. The output of the selector 50-2 is outputted as the detected values of the branch 2 as it is. Simultaneously, the output is stored in the register 51-2 and is outputted as the stored values of the branch 2.

The control signal to the selector 50-1 shown in FIG. 10A is generated by the circuit 46-1 shown in FIG. 9. The control signal to the selector 50-2 shown in FIG. 10B is generated by the circuit 46-2 shown in FIG. 9. In the circuit 46-2, when the branch 2 asynchronous and is not in the receiving operation, the branch 1 is synchronous and is in the receiving operation and that an instruction signal for making a register store a value is on, the control signal of the branch 2 becomes on.

Specifically, when both branches are synchronous, in each of mode detection, carrier synchronization, clock synchronization, carrier frequency deviation detection and TMCC error correction in the synchronous process, a detected value is used for correction and is also stored in a register. For example, when the branch 1 is synchronous and the branch 2 is out-of-synchronous or the branch 2 is re-started from the stoppage for some reason, the control signal of the branch 2 becomes Hi and the stored values of the branch 1 are used for each process in the synchronous process of the branch 2. Conversely, when the branch 1 is out-of-synchronous and the branch 2 is synchronous, the control signal of the branch 1 becomes Hi and the stored values of the branch 2 are used for each process in the synchronous process of the branch 1. For example, FIG. 11 shows the synchronous process of a branch which is made synchronous by applying the stored values of a synchronous branch to its own branch. As is clear when compared with that shown in FIG. 8, there is neither mode detection, clock synchronization, carrier synchronization nor carrier frequency deviation correction in the synchronous process shown in FIG. 11, thereby reducing the time of the synchronous process. The synchronous process in the case of FIG. 11 takes about 36 msec˜249 msec and it is found that it becomes synchronous earlier if either of the second preferred embodiments shown in FIGS. 9, 10A and 10B is used. By using a signal for instructing the use of stored values to generate a control signal, as shown in the circuits 46-1 and 46-2, it can be controlled whether to use the stored values of another branch to activate its own branch.

As described above, according to the second preferred embodiment, when re-synchronizing only one branch or single reception is switched to diversity reception by the control of an external control device in the diversity reception demodulation processing unit, the time of the synchronous process is reduced, thereby reducing time needed to output normal demodulation data (446 msec˜659 msec->36 msec˜249 msec)

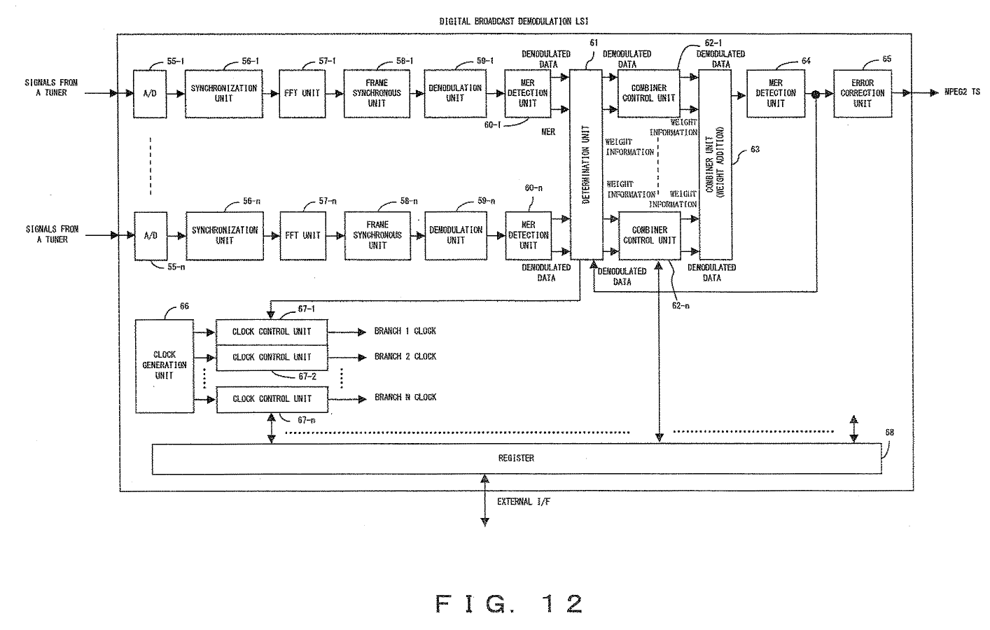

FIGS. 12 through 14 show the block configuration diagram of a digital broadcast demodulation device according to the third preferred embodiment combining both first and second preferred embodiments.

In FIG. 12 a branch comprises the A/D converters 55-1˜55-n, the synchronous units 56-1˜56-n, the FFT units 57-1˜57-n, the frame synchronous units 58-1˜58-n, the demodulation units 59-1˜59-n and the MER detection units 60-1˜60-n. Although in FIG. 12, only two branches are representatively shown, generally n branches are provided. The determination unit 61 determines which branch to stop and which branch to reactivate. The combiner control units 62-1˜62-n are circuits for multiplying demodulation data by weight and the combiner unit 63 is a circuit for performing weight addition, such as a maximum ratio combining and the like. The output of the combiner unit 63 is inputted to the MER detection unit 64 to obtain an MER and the like. An error correction process is applied to demodulation data which has passed through the MER detection unit 64 by the error correction unit 65 and is outputted as user data, for example, MPEG2 data. The determination unit 61 receives the MER of each branch from the MER detection units 60-1˜60-n and an MER after combiner from the MER detection unit 64 and determines the weight of which branch should be made “0”, if the MER after combiner is good. Then, the determination unit 61 controls in such a way that of the clock control units 67-1˜67-n, the clock control unit of a branch to be stopped may stop a clock signal from the clock generation unit 66. The register 68 stores a weight given to the demodulation data of each branch from the combiner control units 62-1˜62-n and the operated/stopped states of the clock control units 67-1˜67-n so that a user can read the stored data using an external interface.

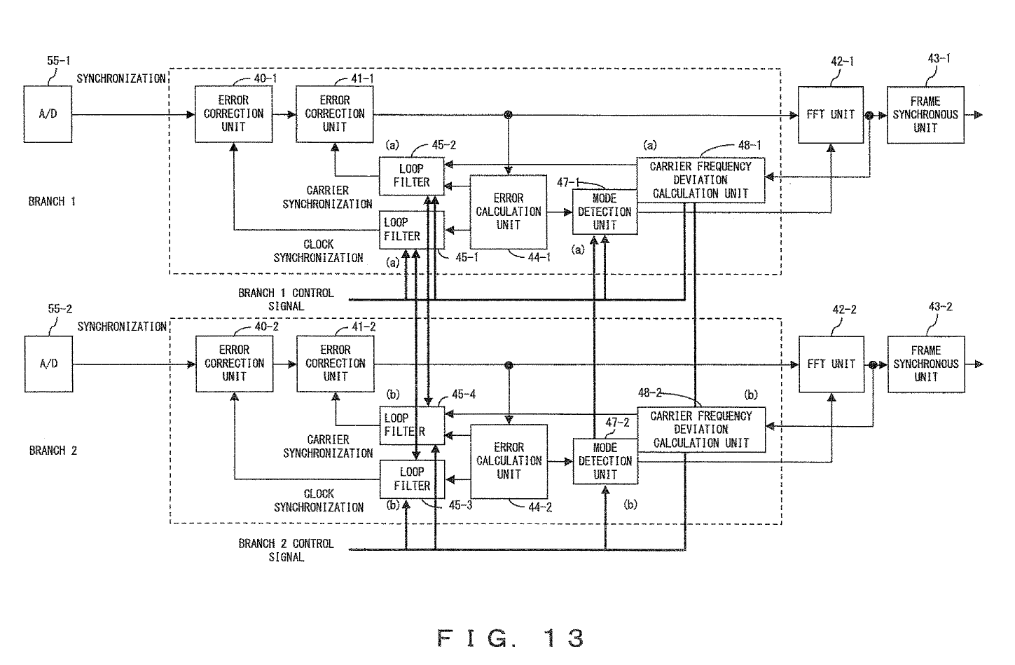

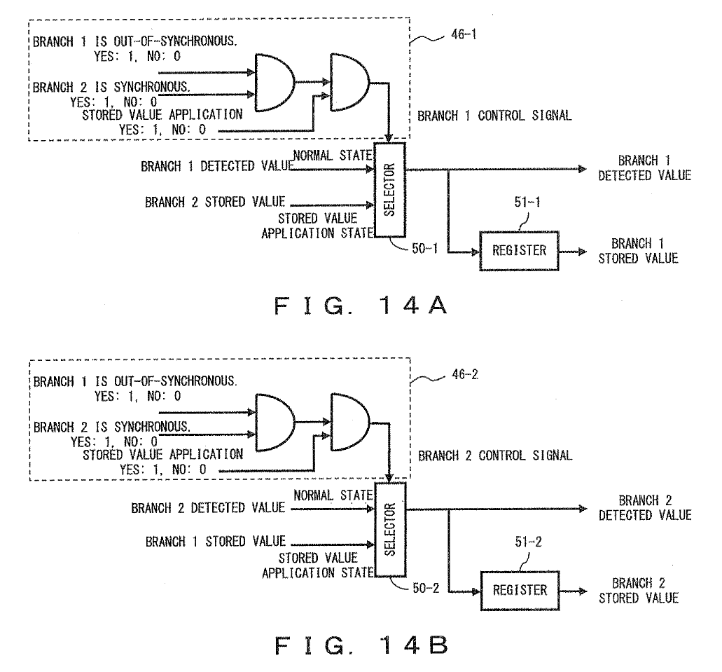

The configurations shown in FIGS. 13 and 14 are the same as those shown in FIGS. 9, 10A and 10B, respectively. Although only two branches are shown, any number of two or more of branches can also be used.

The error calculation units 44-1 and 44-2 calculate frequency errors for clock synchronization and carrier synchronization and give the error values to the loop filters 45-1˜45-4 and the mode detection units 47-1 and 47-2. The loop filters 45-1 and 45-3 and the loop filters 45-2 and 45-4 generate control signals for clock synchronization and carrier synchronization, respectively, and give control signals for clock synchronization and carrier synchronization to the error correction units 40-1 and 40-2 for synchronizing a clock and the error correction units 41-1 and 41-2 for synchronizing a carrier, respectively.

The mode detection units 47-1 and 47-2 give detected mode setting values to the FFT units 42-1 and 42-2, respectively. The carrier frequency deviation calculation units 48-1 and 48-2 obtain signals after FFT and calculate carrier frequency deviations. Then, the calculated result is given to the error correction units 41-1 and 41-2 via the loop filters 45-2 and 45-4, respectively, and are corrected.

The circuit shown in FIG. 14A is mounted on the loop filters 45-1 and 45-2, mode detection units 47-1 and carrier frequency deviation calculation unit 48-1 of the branch 1 and the circuit shown in FIG. 14B is mounted on the loop filters 45-3 and 45-4, mode detection units 47-2 and carrier frequency deviation calculation unit 48-2 of the branch 2.

The circuits shown in FIGS. 14A and 14B are the same as the circuits shown in FIGS. 10A and 10B. The circuits shown in FIGS. 14A and 14B differ from the circuits shown in FIGS. 10A and 10B in that the control signal generation circuits 46-1 and 46-2 of the selectors 50-1 and 50-2, respectively, are used in not only FIG. 13 but also FIGS. 14A and 14B. Specifically, the circuits shown in FIGS. 14A and 14B are provided with registers 51-1 and 51-2, respectively. In the circuit shown in FIG. 14A, the detected values of the loop filters 45-1 and 45-2, mode detection units 47-1 and carrier frequency deviation calculation unit 48-1 of the branch 1 are stored in the register 51-1. The stored values of the register 51-1 is inputted in the selector 50-2 of the circuit shown in FIG. 14B provided in the loop filters 45-3 and 45-4, mode detection units 47-2 and carrier frequency deviation calculation unit 48-2 of the branch 2 as the stored values of the branch 1. The stored values of the register 51-2 shown in FIG. 14B is also given to the selector 50-1 shown in FIG. 14A. When the branches 1 and 2 are synchronous and out-of-synchronous, respectively, and the branch 2 is activated, the setting values in the register 51-1 shown in FIG. 14A is selected and outputted from the selector 50-2 shown in FIG. 14B and are used as the correction values for carrier synchronization, clock synchronization and carrier frequency deviation and the mode detection result. Similarly, when the branches 1 and 2 are out-of-synchronous and synchronous, respectively, too, the stored values of the branch 2 are used as the correction values and the mode detection result of the branch 1.

As described above, when activating a new branch, the rising time of the new branch can be reduced by setting the operation of the new branch using the setting values of an already activated branch.

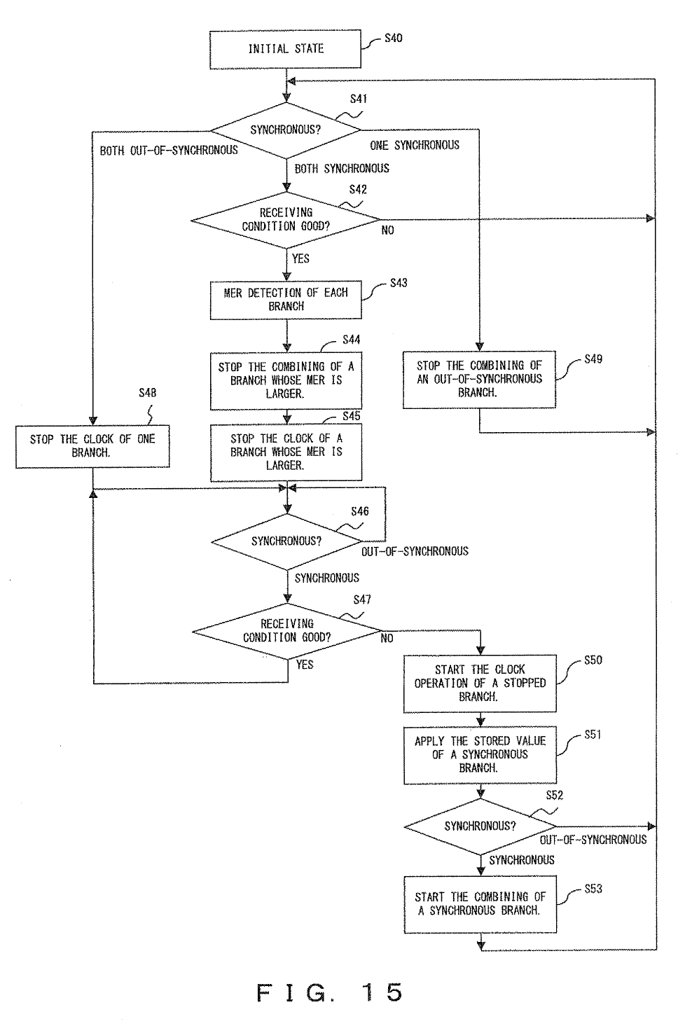

FIG. 15 is a flowchart showing the operation in the case where two branches are used in the third preferred embodiment.

In the initial state (step S40) two branches operate. In step S41 their synchronous states are detected. If neither of them is out-of-synchronous, it is determined that a receiving environment is bad and power consumption is reduced by stopping the clock of one of the branches (step S48). If only one of them is synchronous, the combiner of an out-of-synchronous branch is stopped (step S49) and the flow returns to step S41.

If both of them are synchronous, in step S42, it is determined whether a receiving condition is good. If the determination in step S42 is no, the flow returns to step S41. If the determination in step S42 is yes, in step S43, the MER of each branch is detected. In step S44, the combiner of the signal of a branch with a large MER (worse receiving quality) with the signal of another branch is stopped. In step S46, it is determined whether an operating branch is synchronous. If it is out-of-synchronous, in step S46, it waits until it becomes synchronous. When it becomes synchronous, in step S47, it is determined whether the receiving condition of the synchronous branch is good. If it is good, the flow returns to step S46. If it is determined that it is not good, in step S50, the clock operation of the stopped branch is started and, in step S51, the stored value for synchronous detection information is applied to the branch whose clock operation is started. In step S52 it is determined whether the newly operated branch is synchronous. If it is out-of-synchronous, the flow returns to step D41. If in step S52 it is determined that it becomes synchronous, in step S53 the combiner of the signals of the branch that is newly operated and becomes synchronous is started and the flow returns to step S41.

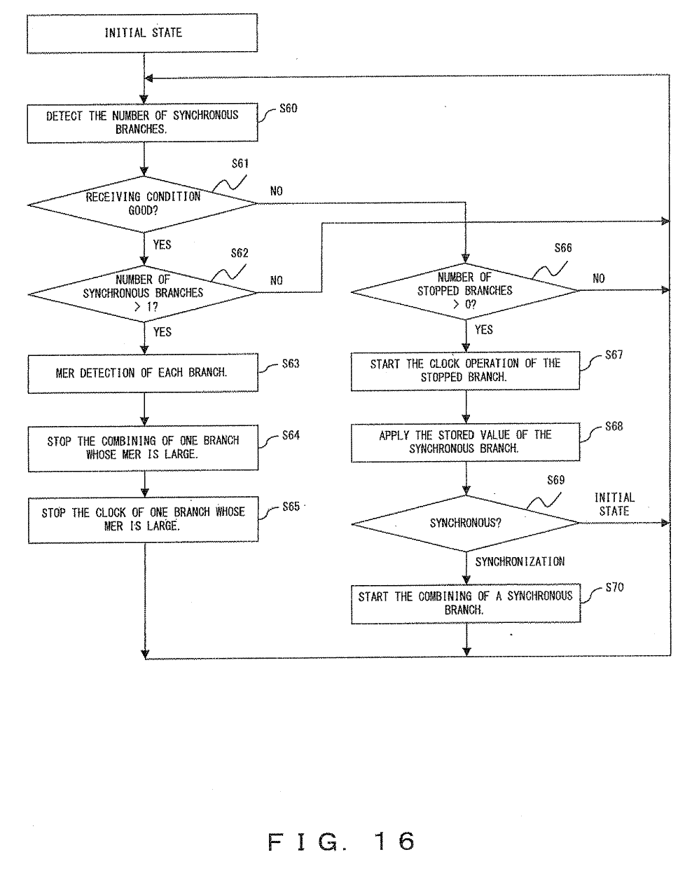

FIG. 16 is a flowchart showing the operation in the case where three or more branches are used in the third preferred embodiment.

As in the case of two branches, all branches operate in the initial state. In this case, their synchronous states and receiving conditions are detected and the combiner of branches and the stoppage/start of a clock are controlled according to the receiving condition. If the receiving condition is good, one branch is stopped. If it is bad, one branch is started. Such an operation is performed in intervals.

Specifically, in step S60, the number of synchronous branches is detected. In step S61 whether the receiving condition is good is determined by detecting the MER after combiner. If the receiving condition is good, in step S62, it is determined whether the number of synchronous branches>1. If the determination in step S62 is no, the flow returns to step S60. If the determination in step S62 is yes, in step S63, the MER of each branch is detected. Then, in step S64, the combiner of a branch whose MER is the largest is stopped. In step S65, clock supply to the branch whose combiner is stopped is stopped and the flow returns to step S60.

If the determination in step S61 is no, in step S66, it is determined the number of stopped branches>0. If the determination in step S66 is no, the flow returns to step S60. If the determination in step S66 is yes, in step S67, the clock operation of the stopped branch is started. In step S68, the stored value of the synchronous detection information of the already synchronously operated branch is applied to the branch whose clock operation is started. In step S69, it is determined whether the newly operated branch is synchronous. If it is out-of-synchronous, the flow returns to step S60. If it is synchronous, in step S70 the combiner of the signals of the branches that are newly operated and whose become synchronous is started and the flow returns to step S60.

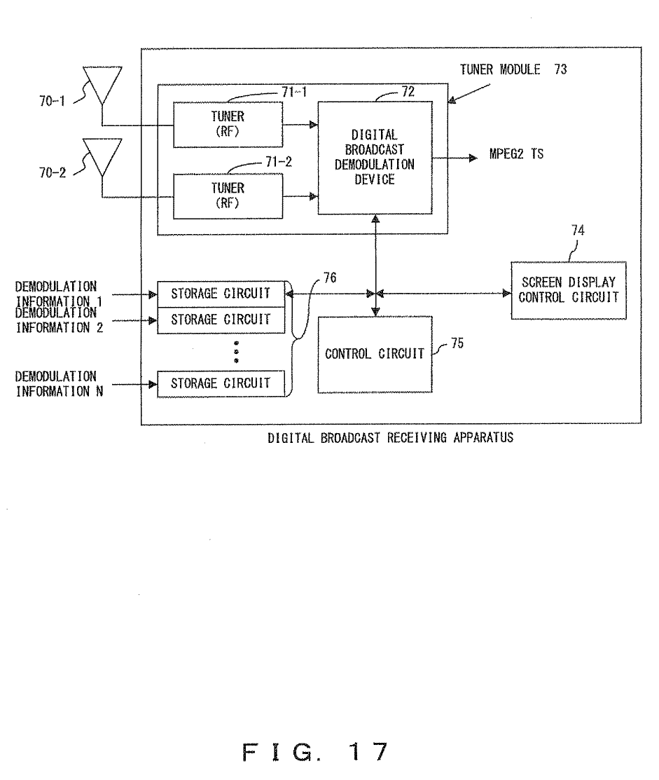

FIG. 17 is the block configuration diagram of a digital broadcast receiving apparatus provided with the digital broadcast demodulation device to which the preferred embodiment of the present invention is applied.

For example, in the case of two branches, the digital broadcast demodulation device 72 is mounted on a tuner module 73 together with two tuners (RF) 71-1 and 71-2. Antennas 70-1 and 70-2 are attached to the two tuners 71-1 and 71-2, respectively. A control circuit 75 controls the digital broadcast demodulation device 72. The same number as the channels of digital broadcast of storage circuits 76 are provided, which store demodulation information 1-N of each channel. A screen display control circuit 74 controls to display user data, such as an MPEG2 signal and the like, outputted from the digital broadcast demodulation device 72.

According to the above configuration, if a receiving condition is good, the branch stopped state of the demodulation device is read from the control circuit 75 of the digital broadcast demodulation device 72. If there is a sopped branch, using the stopped branch a channel other than a view channel can be searched for, demodulation information can be stored and a viewable channel can be displayed.

What is claimed is:

1. A demodulation circuit, comprising:
a first demodulation circuit receiving a signal and generating a first demodulation signal;
a second demodulation circuit receiving the signal and generating a second demodulation signal;
a combiner unit generating a combined demodulation signal by composing the first and second demodulation signals;
a first detection unit detecting a receiving condition on the base of the combined demodulation signal and outputting a detection signal; and
a control unit stopping the combiner of either of the first or second demodulation circuit on the basis of the detected signal and controlling stoppage of either of the first or second demodulation circuit.

2. The demodulation circuit according to claim 1, further comprising:
a second detection unit detecting a receiving condition on the basis of the first demodulation signal; and
a third detection unit detecting a receiving condition on the basis of the second demodulation signal, wherein
the control unit selects one whose receiving condition is worse from the first and second demodulation circuits and stops the combiner.

3. The demodulation circuit according to claim 2, wherein
each of the first, second and third detection units is one of an MER detection circuit, a C/N detection circuit and an error correction circuit.

4. The demodulation circuit according to claim 1, further comprising
a clock generation source supplying the first and second demodulation circuits with a clock,
wherein
the control of stopping either the first or second demodulation circuit is a control of stopping supply of the clock.

5. The demodulation circuit according to claim 4, wherein
a detection operation of the second or third detection unit is stopped by stopping supply of the clock.

6. The demodulation circuit according to claim 1, wherein
information of another channel can be obtained using the first or second demodulation circuit the combiner of which is stopped.

7. The demodulation circuit according to claim 1, wherein
if it is determined that a receiving condition becomes bad from a detection result of the first detection unit, combiner of the first or second demodulation circuit the combiner of which is stopped is re-started.

8. The demodulation circuit according to claim 1, wherein
the first demodulation circuit further comprising a first synchronous circuit and
the second demodulation circuit further comprising a second synchronous circuit,
wherein
when re-starting the combiner, the first or second synchronous circuit which is stopped is synchronized using synchronous information of the first or second synchronous circuit which is operating.

9. The demodulation circuit according to claim 1, wherein
supply of the clock to the first or second stopped demodulation circuit is started and then the combiner by the combiner unit is re-started.

10. A demodulation terminal, comprising:
a first demodulation circuit receiving a signal and generating a first demodulation signal;
a second demodulation circuit receiving the signal and generating a second demodulation signal;
a combiner unit generating a combined demodulation signal by composing the first and second demodulation signals;
a first detection unit detecting a receiving condition on the base of the combined demodulation signal and outputting a detection signal;
a control unit stopping the combiner of either of the first or second demodulation circuit on the basis of the detected signal and controlling stoppage of either of the first or second demodulation circuit;
a first antenna connected to the first demodulation circuit, receiving the signal;
a second antenna connected to the second demodulation circuit, receiving the signal; and
a reproduction processing unit processing the combined decoded signal and reproducing the signal.

11. A demodulation device comprising:
a first synchronous unit extracting a first clock from a carrier signal;
a second synchronous unit extracting a second clock from the carrier signal;
a first detection circuit outputting a first detection signal indicating the out-of-synchronization of the first synchronous unit;
a selection circuit inputting first synchronous information of the first synchronous unit and second synchronous information of the second synchronous unit and transmitting the second synchronous information to the first synchronous unit on the basis of the first detection signal;
a first demodulation circuit demodulating output of the first synchronous unit;
a second demodulation circuit demodulating output of the second synchronous unit; and
a combiner unit composing first demodulation signal of the first demodulation circuit and second demodulation signal of the second demodulation circuit.

12. The demodulation device according to claim 11, wherein
the first synchronous unit further comprises:
a carrier frequency deviation calculation unit;
a filter circuit outputting the first synchronous information on the basis of output of the carrier frequency deviation calculation unit; and
a clock error correction circuit correcting a clock error on the basis of output of the filter circuit.

13. The demodulation device according to claim 11, wherein
the second demodulation circuit further comprises:
a second detection circuit outputting a second detection signal indicating out-of-synchronization, and
the first and second synchronous units transmit the first and second synchronous information, respectively, to each other.

14. The demodulation device according to claim 13, wherein
the first or second detection circuit is a frame synchronous circuit.

15. The demodulation device according to claim 11, wherein
the selection circuit further comprises:
a register storing the outputted first or second synchronous information.
